(19) United States
(12) Patent Application Publication
(10) Pub. No.: US 2002/0186817 A1
(43) Pub. Date: Dec. 12, 2002

(54) Apparatus for filtering a beam of electromagnetic radiation

(76) Inventors: Bernhard Schukalski, Bayreuth (DE); Matthias Weig, Marktredwitz (DE)

Correspondence Address: SCHIFF HARDIN & WAITE, 6600 SEARS TOWER, 233 S WACKER DR, CHICAGO, IL, 60606-6473, US

(21) Appl. No.: 10/139,871

(22) Filed: May 7, 2002

(30) Foreign Application Priority Data
May 10, 2001 (DE) 10122694.2

(51) Int. Cl. G21K 3/00

(52) U.S. Cl. 378/156

(57) ABSTRACT

An apparatus for filtering a beam of electromagnetic radiation, particularly an x-ray beam with different filer stages or levels has two rotation elements that are rotationally attached to a base part, each having at least one filter, the respective filters being different from one another. The two rotation elements are arranged at the base part 50 that a serial arrangement of a filter of the first rotation element and a filter of the second rotation element can be introduced into the beam, so that different filter stages can be set by different rotary motions of the first rotation element via an overriding clutch. Only a single drive is used to generate a rotary motion of the first rotation element. The apparatus enables a large number of filter stages to be selected with a compact structure.

### BACKGROUND OF THE INVENTION

1. Field of the Invention

The present invention is directed to an apparatus for filtering a beam of electromagnetic radiation, particularly an x-ray beam, with different filter stages.

2. Description of the Prior Art

In a medical x-ray apparatus, the “quality” of the radiation, i.e. the energy distribution of the x-ray quanta, is essentially defined by filtering in addition to the voltage at the x-ray tube. The filtering of the x-rays is particularly intended to eliminate all low-energy quanta that do not significantly contribute to the imaging and only lead to an unnecessary beam content. As a result of the filtering, the center of gravity of the energy distribution is displaced toward higher values—the radiation is “hardened”. Filter materials that are often employed are aluminum and, given higher-energy radiation, copper.

Particularly for cardiological examinations, copper pre-filters are required with different filter stages or: levels, i.e. with different absorption values.

### SUMMARY OF THE INVENTION

An object of the present invention is to provide a filter device with which a large number of different filter stages or: levels can be achieved with little apparatus outlay.

In an apparatus of the type initially described, this object is inventively achieved by a first rotation element rotatably in communication with a base part and having at least one filter, or having at least two filters different from one another, and a second rotation element rotationally in communication with the base part and having at least one further filter, or having at least two further filters different from one another, with the rotation elements being arranged at the base part so that a serial arrangement of a filter of the first rotation element and a filter of the second rotation element can be introduced into the ray beam. The various filter stages can be set with different rotary motions of the first rotation element and/or the second rotation element.

For example, the two rotation elements can be fashioned as rotatable discs. A high number of filter stages or filter settings can be realized by combination of the filters attached to the two disks.

Preferably, at least some of the filters of one of the rotation elements not identical to the filters of the other rotation element. An especially high number of filter stages then can be achieved.

In a preferred development, the rotational axes of the two rotation elements are coaxial. The second rotation element is preferably guided on a shaft proceeding centrally through the first rotation element. Such a design allows a structure that is simple and compact.

For a remote-controlled and/or automatic setting of different filter stages, it is expedient to provide a drive for generating a rotary motion of the first rotation element. The drive is preferably implemented such that the first rotation element is rotatable in both direction.

In another preferred embodiment, the second rotation element is coupled to the first rotation element via an overriding clutch. As a result an especially advantageous operation is possible. Only a single drive is required, this, for example driving the first rotation element. In the blocked condition of the overriding clutch, i.e. in one of the two possible rotation directions, both rotation elements are driven to rotate in common by the drive. In this condition, a desired filter of the second rotation element is positioned in the beam path. Subsequently, the desired filer of the first rotation element that yields the desired filter level in combination with the filter of the second rotation element that has already been set, is turned by driving the first rotation element in the opposite direction with the clutch is in the overriding condition until the desired filter of the first rotation element is also positioned in the beam path. The two rotation element scan thus be rotated independently of one another; nonetheless, only a single drive is required. An extremely compact structure is thus achieved. Expediently, a rotational motion of the second rotation element is suppressed in the free-running condition given rotation of the first rotation element. For example, the second rotation element is impeded by a friction or wiper contact from being unintentionally moved out of its set position given positioning of the first rotation element. After the positioning has ensued in the inhibited condition of the clutch, the second rotation element is thus retained.

In particular, the filters are copper filters and/or aluminum filters.

The filters of one of the rotation elements that differ from one another are, in particular, characterized by different transmission values.

Preferably, a monitor for monitoring the rotary motion of the first rotation element and/or of the second rotation element is also present. This may be a light barrier. The correct setting of a desired filter stage thus can be monitored by appropriate codings on the rotation elements.

The above-described apparatus of the invention is preferably utilized for filtering the x-ray beam emitted by an x-ray source and is a component of a medical radiological system, particularly for cardiology.

### DESCRIPTION OF THE DRAWINGS

FIG. 1 illustrates a medical x-ray system of the invention in a schematic overview.

FIG. 2 shows a filter device of the invention in detail, in a perspective exploded view.

### DESCRIPTION OF THE PREFERRED EMBODIMENTS

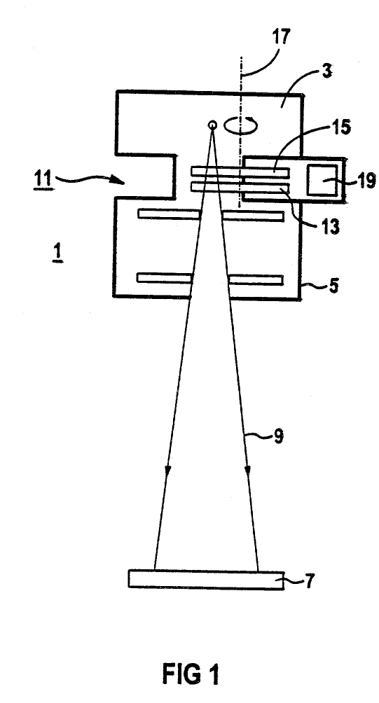

FIG. 1 shows a medical x-ray system 1 with an x-ray tube 3, a depth diaphragm arrangement 5 and a detector means 7 for the registration of an x-ray image. The x-ray tube 3 emits an x-ray beam 9.

A device 11 for filtering the x-ray beam 9 is arranged between the x-ray tube 3 and the depth diaphragm arrangement 5. The filter device 11 has a first rotation element 13 and a second rotation element 15 of the same size that are seated to be rotatable around a common axis 17. An electric motor provided as a drive 19 for driving the rotation elements 13, 15.

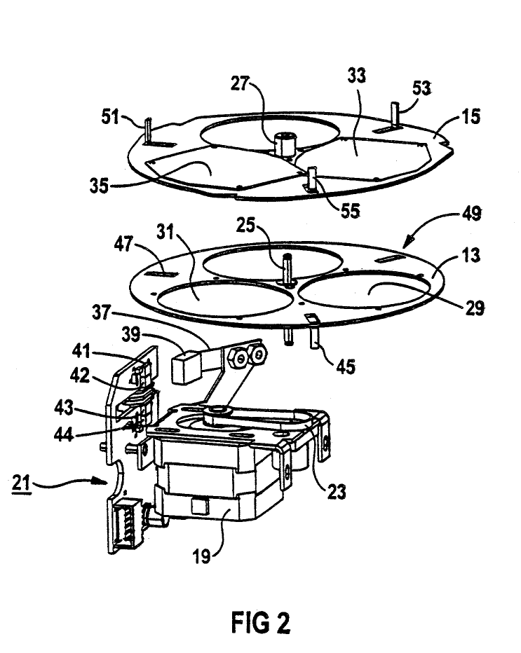

FIG. 2 shows the filter device 11 of FIG. 1 in detail. The device 11 has a base part 21 and the two rotation elements 13, 15.

The drive 19 (stepping motor) is arranged in the base part 12, the rotary motion being transmittable via a toothed belt 23 onto a shaft 25 that is secured in the center of the first rotation element 13 and project toward both sides. In the assembled condition, the shaft 25 is guided in a bearing of the base part 21. The second rotation element 15 is plugged onto the shaft 25 in this condition, so that both rotation elements 13, 15 are in communication with the base part 21. The common rotational axis 17 proceeds through the shaft 25.

The coupling of the second rotation element 15 to the first rotation element 13 occurs with an overriding clutch 27 that is centrally attached to the second rotation element 15.

In the blocked condition of the overriding clutch 27, both rotation elements 13, 15 are turned by the drive 19. In the free-running condition of the override 27, only the first rotation element 13 is turned. The second rotation element 15 is held fast during this rotational movement. In this way, the two rotation elements 13, 15 can be moved and adjusted independently of one another with only one drive 19.

Three circular openings that are of the same size and are spaced from one another at the same azimuthal angle are present in each of the disk-shaped rotation elements 13, 15. One of the opening remains empty (“filter thickness of 0 mm”), so that the x-ray beam 9 can pass therethrough unattenuated. The two other openings in each rotation element are provided with filters 29, 31, 33 and 35 that are respectively different from one another. The following filter types are present:

a) first rotation element 13:

Filter 29: copper filter having a thickness of 0.3 mm

Filter 31: copper filter having a thickness of 0.1 mm

b) second rotation element 15:

Filter 33: copper filter having an overall thickness of 0.2 mm (two copper plates each 0.1 mm thick)

Filer 35: copper filter having an overall thickness of 0.6 mm (two copper filters having a thickness of 0.3 mm each).

The following filter stages (levels) can thereby be achieved:

| Thickness of the Filter of | Thickness of the filter of | |
|---|---|---|
| the First Rotation | the Second Rotation | Filter stage (thick- |
| Element 13 in mm | Element 15 in mm | ness in mm) |
| 0 | 0 | 0 |
| 0 | 0.2 | 0.2 |
| 0 | 0.6 | 0.6 |
| 0.1 | 0 | 0.1 |
| 0.1 | 0.2 | 0.3 |
| 0.1 | 0.6 | 0.7 |
| 0.3 | 0 | 0.3 |
| 0.3 | 0.2 | 0.5 |
| 0.3 | 0.6 | 0.9 |

A total of 8 different filter stages can thus be realized, deriving form the addition of the filter thicknesses of the two rotation elements 13, 15.

The setting of one of the filter stages occurs in two different motion phases:

A) First, the second rotation element 15 is brought into the desired position with the drive 19 by a movement in the blocking direction of the overriding clutch 27. In this phase, thus, both rotation elements 13, 15 are moved in common. The two rotation elements 13, 15 are then intentionally decelerated. Due to the mass movement of inertia, the second rotation element that is coupled via the clutch 27 would continue to run. In order to prevent this and achieve a short filter-changing time, a retainer element 37 is present. The retainer element 37 is, for example, a latch element or a latch spring having a glide member 39 that glides on a curved surface of the second rotation element 15.

B) For positioning the first rotation element 13, rotation is subsequently carried out in the opposite direction, i.e. in the free-running direction, with the motor 19 and with a retained, second rotation element 15 until the desired filer combination, i.e. filter stage, has been achieved.

The apparatus 11 of the invention also has a monitor for monitoring the rotational movement of the rotation elements 13,15. This is formed by four light barriers 41, 42, 43, 44. Two of the light barriers, 43, 44 interact with coded switch indicators 45, 47 and 49 or the first rotation element 13. Two further light barriers 41, 42 interact with respectively three coded switch indicators 51, 53, 55 at the second rotation element 15. The switch indicators 45, 47, 49, 51, 53, 55 are designed such that one part is reflective and one part is absorbent for light. Four different coding values derive therefrom. The switch indicators 45, 47, 49, 51, 53, 55 are respectively allocated to the openings or filters 29, 31, 33, 35.

The switch indicators 51, 53, 55 for the second rotation element 15 are coded in the following way:

a) no light in the beam path: light of the light barriers 41, 42 is reflected;

b) filter 33 in the beam path: light of the light barrier 41 is absorbed, that of the light barrier 42 is reflected;

c) filter 35 in the beam path: light of the light barrier 41 is reflected, that of the light barrier 42 is absorbed;

d) no defined filter position has been approached, for example during the change of filter or in case of error: light of the light barriers 41, 42 is absorbed.

The switch flags 45, 47, 49 for the first rotation element 13 are analogously coded.

Control electronics for the device 11 are accommodated in the depth diaphragm arrangement 5. Upon every activation, an adjustment run is implemented wherein the number of steps of the stepping motor needed until all filter positioned have been achieved is determined. During operation, the control electronics calculates the necessary number of steps in order to achieve the desired filter position. The light barriers 41, 42, 43, 44, following the completion of a filter change, check the filter position. If an error has occurred, a correction can be initiated.

The number of switch indicators is dependent on the number of filters and openings. More than or fewer than six switch indicators can be present. The number of light barriers is correspondingly adapted. For example, 2ⁿ-1 filers or openings per rotation element can be coded with n light barriers.

Although modifications and changes may be suggested by those skilled in the art, it is the intention of the inventors to embody within the patent warranted hereon all changes and modifications as reasonably and properly come within the scope of their contribution to the art.

We claim as our invention:

1. An apparatus for filtering a beam of electromagnetic radiation, comprising:
a base part;
a first rotation element rotatably mounted at said base part and containing at least one filter;
a second rotation element rotatably mounted at said base part and containing at least one filter which is different from said filter in said first rotation element; and
said first and second rotation elements being mounted at said base part relative to each other so that a serial arrangement of said at least one filter in said first rotation element and said at least one filter in said second rotation element is introducible into said beam allowing different filter stages, respectively formed by combinations of said at least one filter in said first rotation element and said at least one filter in said second rotation element, to be set by different respective rotary motions of at least one of said first rotation element and said second rotation element.

2. An apparatus as claimed in claim 1 wherein each of said first and second rotation elements has a rotational axes, and wherein the rotational axis of said first and second rotational elements are coaxial.

3. An apparatus as claimed in claim 2 further comprising a shaft on which said second rotation element is mounted and rotates, said shaft proceeding centrally through said first rotation element.

4. An apparatus as claimed in claim 1 further comprising a drive unit connected to said first rotation element for producing said rotary motion of said first rotation element.

5. An apparatus as claimed in claim 4 wherein said drive rotates said first rotation element selectively in each of opposite directions.

6. An apparatus as claimed in claim 4 further comprising an overriding clutch coupling said second rotation element to said first rotation element.

7. An apparatus as claimed in claim 6 wherein said overriding clutch as a free-running state which allows rotation only of said first rotation element by said drive and no rotation of said second rotation element.

8. An apparatus as claimed in claim 1 wherein said filter in said first rotation element and said filter in said second rotation element are selected from the group consisting of copper filters and aluminum filters.

9. An apparatus as claimed in claim 1 wherein said first rotation element contains at least two filters with said at least two filters in said first rotation element being different from each other, and wherein said second rotation element contains at least two filters, said at least two filters in said second rotation element being different from each other.

10. An apparatus as claimed in claim 9 wherein said at least two filters in said first rotation element have respectively different transmission values for said beam, and wherein said at least two filters in said second rotation element have different transmission values for said beam.

11. An apparatus as claimed in claim 1 further comprising a monitor which monitors said rotary motion of at least said first rotation element.

12. An apparatus as claimed in claim 11 wherein said monitor is a light barrier monitor.

13. A medical x-ray apparatus comprising:
an x-ray source which generates an x-ray beam; and
a filter for filtering said x-ray beam having a base part, a first rotation element rotatably mounted at said base part and containing at least one filter, a second rotation element rotatably mounted at said base part and containing at least one filter which is different from said filter in said first rotation element, and said first and second rotation elements being mounted at said base part relative to each other so that a serial arrangement of said at least one filter in said first rotation element and said at least one filter in said second rotation element is introducible into said beam allowing different filter stages, respectively formed by combinations of said at least one filter in said first rotation element and said at least one filter in said second rotation element, to be set by different respective rotary motions of at least one of said first rotation element and said second rotation element.

14. An apparatus as claimed in claim 13 wherein said first rotation element contains at least two filters with said at least two filters in said first rotation element being different from each other, and wherein said second rotation element contains at least two filters, said at least two filters in said second rotation element being different from each other.
